(19) United States
(12) Patent Application Publication
(10) Pub. No.: US 2016/0196392 A1
(43) Pub. Date: Jul. 7, 2016

(54) System and Method for Providing Medical Information

(71) Applicant: Nancy Roland, Jackson, MI (US)

(72) Inventor: Nancy Roland, Jackson, MI (US)

(21) Appl. No.: 14/990,403

(22) Filed: Jan. 7, 2016

Related U.S. Application Data
(60) Provisional application No. 62/100,549, filed on Jan. 7, 2015.

(51) Int. Cl. G06F 19/00; G06F 21/62

(52) U.S. Cl. CPC G06F 19/323; G06F 21/6245

(57) ABSTRACT

A computer system and method for providing medical information to medical professionals. The system includes a wearable information storage system having a unique serial number that is securable around a user's wrist. The wearable information storage system contains a computer readable medium for storing medical information of the wearer, which may be accessed by a third party device after receiving a password input. The user's medical information is further included in a profile on a website stored on a database and may be accessed via input of the serial number corresponding to that particular user.

### CROSS REFERENCE TO RELATED APPLICATIONS

This application claims the benefit of U.S. Provisional Application No. 62/100,549, filed on Jan. 7, 2015. The above identified patent application is herein incorporated by reference in its entirety to provide continuity of disclosure.

### BACKGROUND OF THE INVENTION

The present invention relates to medical information systems. More specifically, the present invention relates to medical information systems having a wearable information storage system with a unique serial number that provides medical information only to appropriate medical personnel.

Many individuals such as children, elderly, and physically or mentally impaired persons have medical issues that are not detectable at first glance. Similarly, many individuals suffering from medical ailments have difficulty communicating specific medical issues to others. In emergency situations, it is particularly important for emergency responders such as paramedics to learn of the particular needs of the patient. Further, depending on the situation, the individual may be unable to provide their personal medical information such as primary doctor information, release forms, consent forms, blood type, medical history, medication information, allergies, etc. to the appropriate medical personnel. This may delay treatment for the individual and increase the risk of additional harm. Regardless of the circumstance, if an individual is unable to communicate particular medical issues to a first responder in an emergency situation, there is an increased risk that the medical professional will be unable to treat the individual successfully. Therefore, it is desirable to provide a system and method for providing medical information to emergency personnel when an individual is unable to communicate.

Another issue regarding communication of medical information occurs when an individual is in cardiopulmonary arrest and emergency personnel must choose whether to attempt resuscitation. Resuscitated individuals sometimes suffer severe brain damage and as such have a reduced quality of life, often without the ability to function without constant care. The reduced quality of life and expensive treatments are undesirable to some individuals. Further, other individuals object to lifesaving measures due to personal religious beliefs. For this and other reasons, many individuals do not wish to be resuscitated or receive other lifesaving if they have been in cardiopulmonary arrest for an extended period. However, it is impossible for one injured in such a way to communicate these wishes to an emergency responder. A system and method for providing information to emergency personnel regarding whether or not an individual wishes to be resuscitated is therefore desired.

### SUMMARY OF THE INVENTION

In view of the foregoing disadvantages, the present invention provides a medical information system and method wherein the same can be utilized for providing convenience for the user when providing medical information, including information regarding resuscitation, to an approved medical professional. The present medical information system comprises a housing securable around a user's wrist, a processor, a non-transitory computer readable medium operatively connected to the processor, and a logic stored in the non-transitory computer readable medium that, when executed by the processor, causes the medical information device to perform a method. The method comprises the steps of receiving an input comprising medical information of a user, wherein the input is stored on the computer readable medium, receiving a request for user medical information from an external device, and transmitting the medical information to the external device.

One object of the present invention is to provide a medical information system that stores instructions regarding whether the user wishes to be resuscitated or have other lifesaving measures taken.

Another object of the present invention is to provide a medical information system and method that requires a verification input prior to transmitting medical information device to a third party, wherein the verification input confirms that the third party is an approved medical professional.

A further object of the present invention is to provide a medical information system having a serial number corresponding to a medical information profile on a website stored on a database, wherein input of the serial number is required prior to transfer of medical information to a third party such as a medical professional.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a medical information system according to the present invention.

FIG. 2 shows a diagram of the components of a medical information system according to the present invention.

FIG. 3 shows a perspective view of a third party device accessing a medical information system according to the present invention.

FIG. 4 shows a perspective view of a medical professional using a third party device to retrieve resuscitation information from a medical information system according to the present invention.

### DETAILED DESCRIPTION OF THE INVENTION

Reference is made herein to the attached drawings. Like reference numerals are used throughout the drawings to depict like or similar elements of the medical information system. For the purposes of presenting a brief and clear description of the present invention, the preferred embodiment will be discussed as used for providing medical information to proper medical professionals. The figures are intended for representative purposes only and should not be considered to be limiting in any respect.

As used herein, “logic” refers to (i) logic implemented as computer instructions and/or data within one or more computer processes and/or (ii) logic implemented in electronic circuitry.

As used herein, “computer-readable medium” excludes any transitory signals, but includes any non-transitory data storage circuitry, e.g., buffers, cache, and queues, within transceivers of transitory signals.

According to some embodiments, the operations, techniques, and/or components described herein can be implemented by an electronic device, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more general purpose hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that incorporates hard-wired and/or program logic to implement the techniques and other features of the present disclosure.

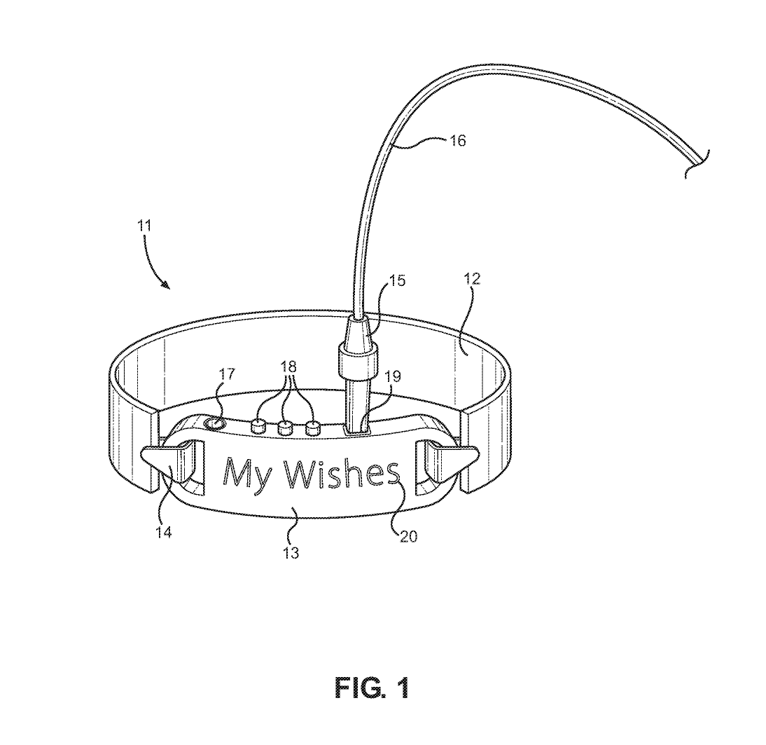

Referring now to FIG. 1, there is shown a perspective view of a medical information system according to the present invention. The medical information system 11 comprises a housing 13 securable to a user's wrist. The housing 13 comprises an open interior volume which houses the various electrical components of the medical information system 11, such as a computer readable medium on which medical information of the wearer is stored. The housing 13 is connected to a loop of a material 12 that wraps around the wearer's wrist. The loop of material 12 may be any suitable material for supporting the medical information system on a user's wrist. In some embodiments, the loop of material 12 may be of an adjustable length in order to accommodate different sizes of users. The loop of material 12 may be connected to opposing ends of the housing 13 via clips 14 and corresponding apertures in the housing 13, but other means of securing the loop of material 12 to the housing 13 may be utilized in order to provide an adjustable fit. The loop of material 12 may also be flexible and expandable to allow for different wrist sizes.

The medical information system 11 further comprises control buttons 18 which may be utilized to control various functions of the medical information system. A charging port 17 is disposed on the housing 13 and is connectable to a power source for recharging a battery disposed within the housing 13. Indicia 20 is further disposed on an outer surface of the housing 13 which allows medical professionals and others to easily identify the medical information system. For example, the indicia 20 may comprise the phrase “My Wishes” in order to notify medical professionals that the system on the wearer's wrist includes medical information that may be necessary for proper treatment of the user. Additionally, the indicia 20 may further comprise a serial number unique to each particular user of the medical information system 11. An individual requesting information stored on the medical information system may be required to first input the serial number as verification that the third party is a medical professional and to ensure that the correct medical information is provided.

The housing 13 further comprises a port 19 for connecting the medical information system 11 to an external computing device such as a computer, laptop, smartphone, etc. The port 19 may comprise a USB port connectable to another device via a connector 15 and a corresponding cable 16. In one embodiment of the invention, the connector 15 may comprise a male USB plug while the port 19 may comprise a female USB outlet. In this way, the medical information system is capable of connecting to any device that utilizes USB technology for transferring information.

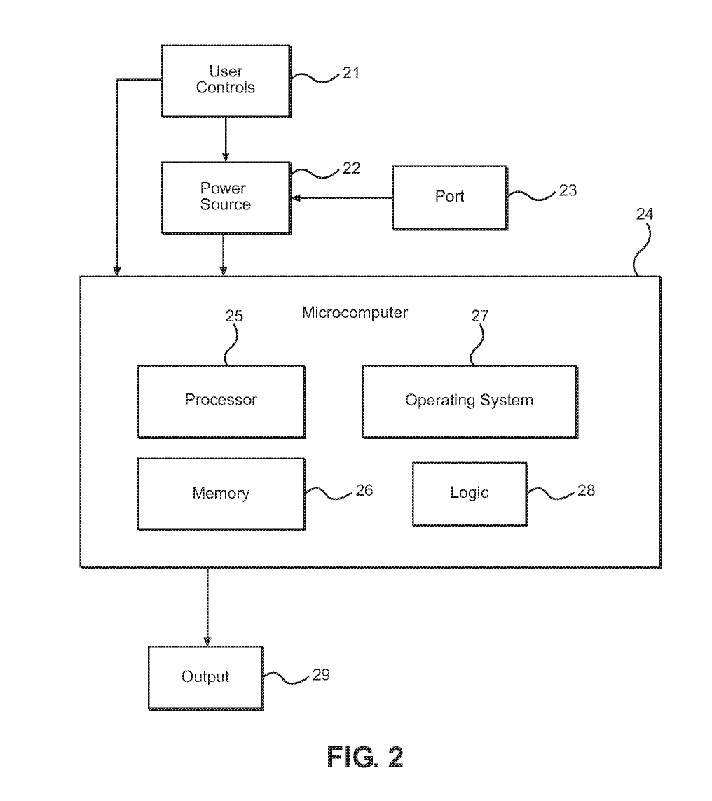

Referring now to FIG. 2, there is shown a diagram of the components of a medical information system according to the present invention. The medical information system comprises a power source 22 such as a battery which is operatively connected to a processor 25, a computer readable medium such as a memory 26, and a logic 28 stored on the memory 26. When executed by the processor 25, the logic 28 causes the medical information system to perform a method that provides the medical information to an appropriate third party, such as a medical professional. In a first step, the logic 28 causes the system to receive an input from the user regarding the user's medical information and store the input on the memory 26. The input from the user may comprise any medical information of the user such as, for example, current medications, diseases, allergies, and/or instructions regarding resuscitation or other lifesaving measures in the event the user is in cardiopulmonary arrest.

In a next step, after receiving a request for medical information from a third party connected to the medical information system, the logic 28 then causes the medical information system to require input of a password before providing information to the third party. One or more passwords may be stored on the memory 26. In one embodiment, the passwords are only accessible to medical professionals who are authorized by the user to provide care when necessary. The logic 28 causes the medical information to be transferred to the third party device only if a password received from the third party device matches a password stored on the medical information system. In this way, only individuals or organizations authorized by the user are able to access the medical information stored on the medical information system.

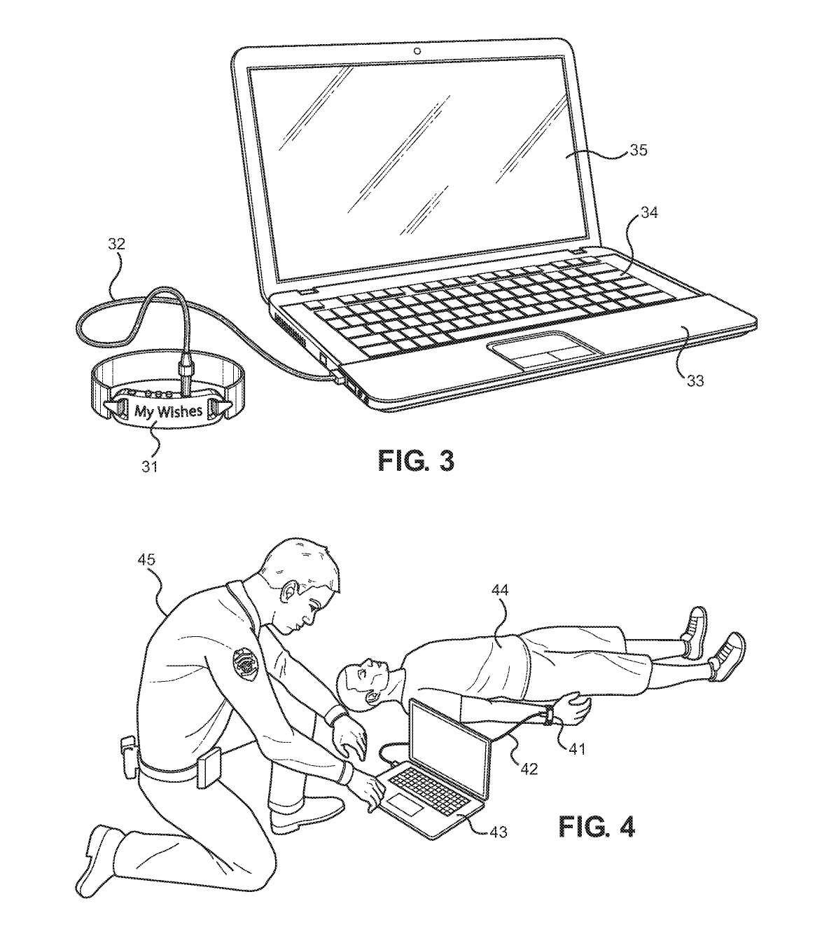

Referring now to FIG. 3, there is shown a perspective view of a third party device accessing a medical information system according to the present invention. The third party device represented as a laptop 33, but the medical information system may be accessible via a cable 32 connectable to any computing device such as a smartphone, tablet, or computer. In one embodiment of the invention, the medical information of the user may also be included in a profile on a website stored on a database that is only accessible to medical professionals. Further, the medical information may only be transferred upon input of the serial number corresponding to the user's medical information system. This prevents the medical information of a different user from being accessed and provides correct information to medical professionals.

Referring now to FIG. 4, there is shown a perspective view of a medical professional using a third party device to retrieve resuscitation information from a medical information system according to the present invention. In the illustrated scenario, a user 44 of the medical information system 41 is incapacitated when encountered by a medical professional 45. In order to access the medical information of the user 44 stored on the medical information system 41, the medical professional 45 is required to input a password only known to certain approved organizations. For example, the password may be provided to the user's primary doctor, hospitals, EMT's, and other appropriate medical professionals or organizations. After inputting the correct password, the medical information is transferred from the medical information system 41 to a third party device 43 via a transfer cable 42. The medical professional 45 then may access the user's 44 medical information, which may include information such as instructions regarding whether or not to resuscitate the user 44 or perform other lifesaving measures in the event the user 44 is found in cardiopulmonary arrest. The medical professional can then make an informed decision regarding treatment of the user 44 and provide proper treatment according to the user's instructions based on the medical information provided.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A medical information system and method comprising:
a housing securable around a user's wrist;
a processor;
a non-transitory computer readable medium operatively connected to the processor;
a logic stored in the non-transitory computer readable medium that, when executed by the processor, causes the medical information system to perform a method, the method comprising the steps of:
receiving an input comprising medical information from a user, wherein the input is stored on the computer readable medium;
receiving a request for user medical information from an external device; and
transmitting the medical information to the external device.

2) The medical information system of claim 1, wherein the medical information system comprises a serial number disposed on an outer surface of the housing, the serial number corresponding to a user profile stored on a database, and wherein the method further comprises the steps of:
receiving a request from a third party for medical information of the user, the request comprising at least a serial number; and
if the serial number received matches the serial number of the user's medical information device, then providing the user's medical information to the third party.

3) The medical information system of claim 2, wherein the method further comprises the steps of:
requiring the third party to provide a verification message regarding the third party's status as a medical professional; and
if it is unable to be verified that the third party is a medical professional, then declining to provide the user's medical information to the third party.

4) The medical information system of claim 1, wherein the medical information stored on the computer readable medium comprises instructions regarding resuscitation of the user.

5) The medical information system of claim 3, wherein the computer readable medium further comprises one or more verification passwords stored thereon.

6) The medical information system of claim 5, wherein the verification message comprises at least one of the one or more verification passwords.

7) The medical information system of claim 1, wherein the medical information system further comprises a port configured to connect the medical information system to a third party computing device.

8) The medical information system of claim 1, wherein the method further comprises the steps of:
prompting the third party to provide an input comprising one or more of the verification passwords; and
if the medical information device receives an input from the third party computing device comprising one or more of the verification passwords, then providing the medical information to the third party.

9) The medical information system of claim 1, wherein the housing comprises an outer surface having identifying indicia disposed thereon.

10) The medical information system of claim 1, further comprising a battery disposed within the housing.

11) The medical information system of claim 10, wherein the housing further comprises an input in electrical communication with the battery configured to connect to an external power source and charge the battery.
